(19) United States
(12) Patent Application Publication
(10) Pub. No.: US 2003/0008702 A1
(43) Pub. Date: Jan. 9, 2003

(54) Gaming machine

(76) Inventor: Jason Meyer, Wollstonecraft (AU)

Correspondence Address: ARTER & HADDEN, LLP, 1100 HUNTINGTON BUILDING, 925 EUCLID AVENUE, CLEVELAND, OH, 44115-1475, US

(21) Appl. No.: 10/189,929

(22) Filed: Jul. 3, 2002

(30) Foreign Application Priority Data
Jul. 4, 2001 (AU) PR6107

(51) Int. Cl. A63F 13/00

(52) U.S. Cl. 463/16

(57) ABSTRACT

A gaming machine that has a feature made up of a number of separate feature games 22-27, allowing the machine to offer generous potential feature wins to attract players, but then maintain their interest with lower yielding feature games.

### BACKGROUND OF THE INVENTION

The present invention relates to gaming machines. The invention has been developed primarily for computerized, spinning reel type poker machines and will be described herein with specific reference to that application. However it will be appreciated that the invention is not limited to that particular type of gaming machine.

Gaming machines have long been known and are now one of the most common forms of gambling. One of the oldest and best known forms of gaming machine is the spinning reel type poker machine. These machines use a series of three or more reels, each reel having symbols on its peripheral edge. The reels are rotated upon placing a bet and then stopped to produce a randomly selected array of symbols. Winnings are paid if the array of symbols matches one of the predetermined winning combinations.

Recently these gaming machines have been computerized with a video screen display replacing the physically rotating reels. The display screen typically presents an array of symbols in five columns and three rows equating to the symbols that would normally be seen on the five rotating reels of the old style mechanical machines. Computerized machines have allowed players to bet on the symbols appearing in one or more rows or columns instead of just the line of symbols across the middle row which was the traditional practice of the old style mechanical machines. Eventually all the practical “paylines” of symbols available in the array were being used in computerized gaming machines.

In an ongoing effort to further enhance the gaming experience, game designers have added secondary games of a different nature to the primary or base game. The secondary games are often referred to as “features”. The feature would appear upon some trigger event, such as a predetermined outcome in the base game, and then revert back to the base game at the completion of the feature. The feature offers the player some variety in the gaming experience and it also provides the game designer with an opportunity to award the player with significant winnings as an incentive to continue playing the machine.

The use of a feature is also an effective way of altering the “volatility” of a gaming machine. The “volatility” of a gaming machine refers to the expected frequency of wins and the corresponding amount paid for each win. Over time all gaming machines return a set percentage of the bets received as winnings. However, a machine with a high volatility will return this percentage through fewer wins of higher value and a low volatility machine will have more wins of less value.

A feature with relatively high volatility will provide an opportunity for greater wins which can make the game more exciting for the player. However, because of the high volatility, the number of wins will usually be lower and this can generate negative player sentiment towards the feature. Nevertheless, when a player is selecting a gaming machine to play, any machines that can offer high yielding wins during the feature will often receive favorable consideration. However, as discussed above, the machine can then go on to lose its appeal in a relatively short period of time due to the high volatility of the feature.

### SUMMARY OF THE INVENTION

In accordance with the present invention, there is provided a gaming machine which overcomes or ameliorates at least one of the disadvantages of the earlier gaming machines or which provides a useful alternative.

Further, in accordance with the present invention, there is provided a gaming machine comprising:

means adapted to display a base game that has random outcomes, wherein the random outcomes include predetermined winning outcomes;

means adapted to accept a bet on the occurrence of at least one of the winning outcomes;

means adapted to pay winnings on the occurrence of any winning outcomes carrying a bet; and

means adapted to display a feature in response to a trigger in the base game, wherein the feature includes more than one feature game, wherein each of the feature games has random outcomes including at least one winning outcome, and wherein the probability of a winning outcome occurring in at least one of the feature games is different from the probability of a winning outcome for the other feature games.

By providing multiple feature games having a range of different volatilities, the machine can display the large awards available through a winning outcome in a high volatility feature while maintaining the player's interest in the game through more frequent wins from lower volatility features.

Preferably, the probability of a winning outcome is different for each of the feature games. In a further preferred form, the feature operates the feature games sequentially. In yet another preferred form, a predetermined outcome in the last feature game in the sequence reinitiates the feature.

In some preferred embodiments, the base game produces an array of randomly selected symbols in five columns and three rows, the trigger is at least one predetermined combination of symbols in the array, and the feature includes six separate feature games, each of the six feature games have an individual probability of providing a winning outcome, and wherein the six feature games operating sequentially. Preferably, a winning outcome in any of the first five feature games provides a predetermined number of free games.

A “free game” is a reference to a single game event where the player does not need to place a bet before the game operates. If the free game produces a winning outcome the player accumulates the winnings in the usual fashion. The game events are single operating cycles of any suitable type of game of chance. For example, the free games may be provided by simply spinning the five reels in the base game. However, to clearly indicate that the machine is operating in feature mode, the display screen will be significantly different during the feature. Therefore, if the game events are free spins on a set of five reels, the player will unmistakably recognize that the game is in feature mode. To further reinforce this, the symbols on the five reels shown during the feature mode may be different to the symbols shown on the five reels used by the base game.

In some preferred forms, the predetermined number of free games awarded is determined in accordance with the individual probability of a winning outcome associated with the particular feature game. Optionally, the first five feature games can award the same number of free games, wherein any wins during the free games will be adjusted in accordance with the individual probability of a winning outcome occurring in each of the first five feature games. In this form of the embodiment, any wins from the free games awarded by the first feature game may be multiplied by two, any wins from free games awarded by the second feature game are multiplied by three, any wins from free games awarded by the third feature game are multiplied by four, any wins from free games awarded by the fourth feature game are multiplied by five, and any wins from free games awarded by the fifth feature game are multiplied by ten. As discussed above, the winning outcome in the sixth feature game will re-initiate the feature.

Conveniently, the six feature games are six reels with symbols on their peripheral edges, at least one of the symbols being a winning symbol wherein the reels are spun and then stopped in order to randomly select one of the symbols. Preferably, the six feature game reels spin in sequence wherein any of the free games awarded by one of the feature game reels must be completed before the next feature game reel can spin.

In a particularly preferred embodiment, any winnings from the free games awarded by the feature games will be increased or decreased depending on the number of paylines that were carrying a bet when the feature was triggered as well as the amount bet on those paylines. Of course, if the machine is configured to multiply any wins from the free games the total winnings are credited to the player after being multiplied by the factor associated with the feature game reel that provided the free games.

These and other advantages, aspects, and features will be understood by one of ordinary skill in the art upon the reading and understanding of the specification.

### BRIEF DESCRIPTION OF THE DRAWINGS

A preferred embodiment of the present invention will be described by way of example only with reference to he accompanying drawings in which:

FIG. 1 shows a schematic representation of the video screen on a gaming machine according to the present invention during the base game; and

FIG. 2 shows a schematic representation of the video screen during the feature.

### DETAILED DESCRIPTION OF THE PREFERRED EMBODIMENTS

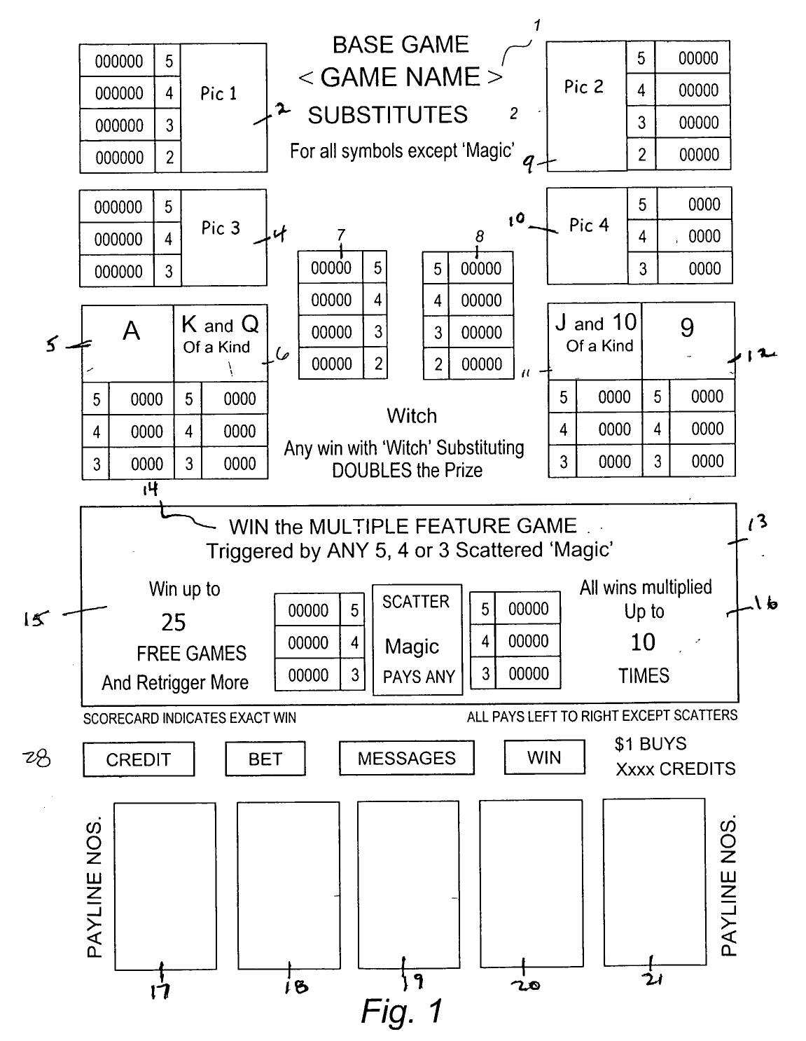

Referring to FIG. 1, the base game display is shown in a schematic form. The layout of the display is similar to existing spinning reel type poker machines. The upper portion of the screen shows the game name 1, any substituting wild cards 2, score card tabulations showing the credits awarded for the occurrence of certain multiples of symbols in any payline carrying a bet (3, 4, 5, 6, 7, 8, 9, 10, 11, 12). The credits awarded are shown as zero, however, it will be appreciated that the game designer will insert the appropriate values in accordance with the probability of the combination and the set percentage return of the machine. In the middle portion of the screen is information about the feature 13, the trigger events 14 required in order to initiate the feature and the wins (15, 16) that are available through the feature. In the lower portion of the screen is the array of randomly selected symbols arranged in five columns and three rows in order to simulate five separate reels 17, 18, 19, 20 and 21 that would be seen on the old style mechanical machines.

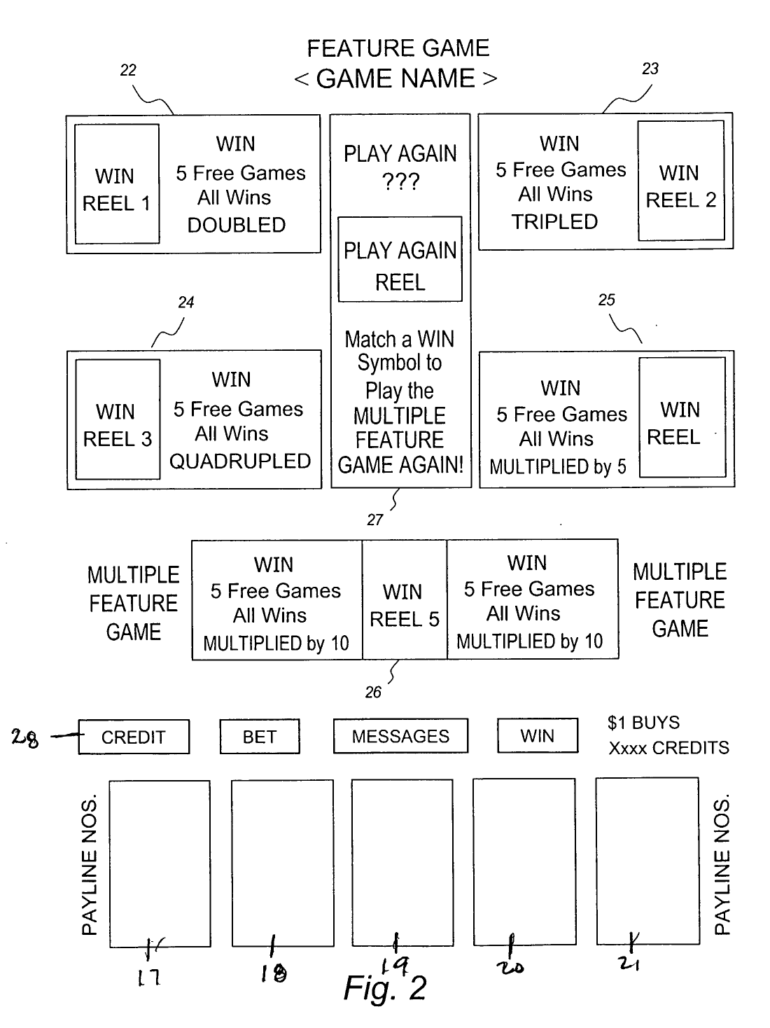

As shown in the middle portion of the screen the feature triggers when there are 5, 4 or 3 “magic” symbols appearing in the array formed when the reels 17, 18, 19, 20 and 21 stop spinning. When the feature is triggered, the screen changes to that schematically shown in FIG. 2. During the feature the upper portion of the screen displays six separate reels 22, 23, 24, 25, 26 and 27. Reels 22-26 are win reels which award the player five free games in the base game if the win reels stop on a win symbol designating a winning outcome. The feature reel 27 determines whether the entire feature will re-initiate such that the win reels spin again. Again, the win symbol on the play again reel 27 designates a winning outcome.

Win reel 1 22 spins first in response to the trigger. As shown in FIG. 2, if win reel 1 stops on a win symbol the player receives five free games whereby the base game reel 17, 18, 19, 20 and 21 spin five times without the player needing to place any bets. Any of the predetermined winning outcomes occurring during the free games will be awarded winnings on the basis of the paylines that were carrying a bet when the feature was triggered and the number of credits bet per payline. Furthermore these winnings are doubled and added to the total credits shown on the credit meter 28.

After win reel 1 has spun and any free games won completed, win reel 2 23 spins. As with win reel 1, if win reel 2 stops on a win symbol the player is awarded five free games played on the base game reels 17, 18, 19, 20 and 21. However any winnings from free games initiated by win reel 2 are tripled and added to the credit meter 28.

Likewise the remaining win reels offer five free games on the occurrence of a win symbol. However the winnings multiplier associated with win reels 3 24, 4 25 and 5 26 are 4, 5 and 10 respectively. Therefore the occurrence of a win symbol on win reel 5 is likely to provide the player with a substantial amount of additional credits. Accordingly, the portion of the screen dedicated to this reel and the signage displaying the winnings that it can provide is larger than the area of the display screen allocated to the other win reels.

Finally, the play again reel 27 spins to provide the player with an opportunity to reinitiate the feature. If the win symbol appears on the play again reel 27, win reel 1 is spun and the process of the feature is repeated. If the win symbol does not appear on the play again reel 27 then the machine reverts to the base game mode of operation as shown in FIG. 1. Once back in the base game the player chooses play lines and the number of credits bet per line in order to continue gaming until the next feature triggers.

The different amounts of winnings awarded by each of the win reels dictates their particular probability of achieving a winning outcome. The chance of a winning outcome from win reel 1 will be much higher than that of win reel 5. This provides a feature with multiple levels of volatility but allows the display screen to emphasize the winnings available through the particular feature game that has the highest volatility. The winnings available through the most volatile individual feature game will provide a strong motivation for the player to select that machine and the lower volatility feature games will provide an ongoing incentive to maintain the player's interest. Furthermore by basing the winnings received through the feature game on the number of paylines carrying a bet and the credits bet per payline, the player is encouraged to bet more credits on more lines which in turn increases the return provided by the machine over any given time.

The present invention has been described herein by way of example only. Skilled workers in this field will readily recognize many variations and modifications which do not depart from the spirit and scope of the broad inventive concept. The present embodiments are, therefore, to be considered in all respects as illustrative and not restrictive. Other features and aspects of this invention will be appreciated by those skilled in the art upon reading and comprehending this disclosure. Such features, aspects, and expected variations and modifications of the reported results and examples are clearly within the scope of the invention where the invention is limited solely by the scope of the following claims.

What is claimed is:

1. A gaming machine comprising:
means adapted to display a base game that has random outcomes, wherein the random outcomes include predetermined winning outcomes;
means adapted to accept a bet on the occurrence of at least one of the winning outcomes;
means adapted to pay winnings on the occurrence of any winning outcomes carrying a bet; and
means adapted to display a feature in response to a trigger in the base game, wherein the feature includes at least two feature games, wherein each of the feature games has random outcomes including at least one winning outcome, and wherein the probability of a winning outcome occurring in at least one of the feature games is different from the probability of a winning outcome for the other feature games.

2. A gaming machine according to claim 1 wherein the probability of a winning outcome is different for each of the feature games.

3. A gaming machine according to claim 1 wherein the feature operates the feature games sequentially.

4. A gaming machine according to claim 3 wherein a predetermined outcome in the last feature game in the sequence reinitiates the feature.

5. A gaming machine according to claim 1 wherein the base game produces an array of randomly selected symbols in five columns and three rows, wherein the trigger is at least one predetermined combination of symbols in the array, wherein the feature includes six separate feature games, wherein each of the six feature games has an individual probability of providing a winning outcome, and wherein the six feature games operating sequentially.

6. A gaming machine according to claim 5 wherein a winning outcome in any of the first five feature games provides a predetermined number of free games.

7. A gaming machine according to claim 1 wherein the games are single operating cycles of a game of chance.

8. A gaming machine according to claim 7 wherein the free games are provided by spinning the five reels in the base game.

9. A gaming machine according to claim 8 wherein the display screen is significantly different during the feature.

10. A gaming machine according to claim 9 wherein the symbols on the five reels shown during the feature mode are different from the symbols shown on the five reels used by the base game.

11. A gaming machine according to claim 6 wherein the predetermined number of free games awarded is determined in accordance with the individual probability of a winning outcome associated with the particular feature game.

12. A gaming machine according to claim 6 wherein the first five feature games award the same number of free games and wherein any wins during the free games will be adjusted in accordance with the individual probability of a winning outcome occurring in each of the first five feature games.

13. A gaming machine according to claim 12 wherein any wins from the free games awarded by the first feature game are multiplied by two, any wins from free games awarded by the second feature game are multiplied by three, any wins from free games awarded by the third feature game are multiplied by four, any wins from free games awarded by the fourth feature game are multiplied by five, and any wins from free games awarded by the fifth feature game are multiplied by ten.

14. A gaming machine according to claim 5 wherein the six feature games are six reels with symbols on their peripheral edges, wherein at least one of the symbols is a winning symbol, and wherein the reels are spun and then stopped in order to randomly select one of the symbols.

15. A gaming machine according to claim 14 wherein the six feature game reels spin in sequence, wherein any of the free games awarded by one of the feature game reels must be completed before the next feature game reel spin.

16. A gaming machine according to claim 15 wherein any winnings from the free games awarded by the feature games will be adjusted depending on the number of paylines that were carrying a bet when the feature was triggered and the amount bet on those paylines.

17. A gaming machine according to claim 16 wherein if the machine is configured to multiply any wins from the free games the total winnings are credited to the player after being multiplied by the factor associated with the feature game reel that provided the free games.

18. A method for operating a gaming machine comprising:
displaying a base game that has random outcomes, wherein the random outcomes include predetermined winning outcomes;
accepting a bet on the occurrence of at least one of the winning outcomes;
paying winnings on the occurrence of any winning outcomes carrying a bet; and
displaying a feature in response to a trigger in the base game, wherein the feature includes more than one feature game, wherein each of the feature games has random outcomes including at least one winning outcome, and wherein the probability of a winning outcome occurring in at least one of the feature games is different from the probability of a winning outcome for the other feature games.

19. A method according to claim 18 wherein the probability of a winning outcome is different for each of the feature games.

20. A method according to claim 18 wherein the feature operates the feature games sequentially.

21. A method according to claim 20 wherein a predetermined outcome in the last feature game in the sequence reinitiates the feature.

22. A method according to claim 18 wherein the base game produces an array of randomly selected symbols in five columns and three rows, wherein the trigger is at least one predetermined combination of symbols in the array, wherein the feature includes six separate feature games, wherein each of the six feature games has an individual probability of providing a winning outcome, and wherein the six feature games operating sequentially.

23. A method according to claim 22 wherein a winning outcome in any of the first five feature games provides a predetermined number of free games.

24. A method according to claim 18 wherein the games are single operating cycles of a game of chance and wherein the free games are provided by spinning the five reels in the base game.

25. A method according to claim 24 wherein the symbols on the five reels shown during the feature mode are different from the symbols shown on the five reels used by the base game.

26. A method according to claim 23 wherein the predetermined number of free games awarded is determined in accordance with the individual probability of a winning outcome associated with the particular feature game.

27. A method according to claim 23 wherein the first five feature games award the same number of free games and wherein any wins during the free games will be adjusted in accordance with the individual probability of a winning outcome occurring in each of the first five feature games.

28. A method according to claim 27 wherein any wins from the free games awarded by the first feature game are multiplied by two, any wins from free games awarded by the second feature game are multiplied by three, any wins from free games awarded by the third feature game are multiplied by four, any wins from free games awarded by the fourth feature game are multiplied by five, and any wins from free games awarded by the fifth feature game are multiplied by ten.

29. A method according to claim 22 wherein the six feature games are six reels with symbols on their peripheral edges, wherein at least one of the symbols is a winning symbol, and wherein the reels are spun and then stopped in order to randomly select one of the symbols.

30. A method according to claim 28 wherein the six feature game reels spin in sequence, wherein any of the free games awarded by one of the feature game reels must be completed before the next feature game reel spin, and wherein

31. A method according to claim 30 wherein any winnings from the free games awarded by the feature games will be adjusted depending on the number of paylines that were carrying a bet when the feature was triggered and the amount bet on those paylines.

32. A method according to claim 31 wherein if the machine is configured to multiply any wins from the free games the total winnings are credited to the player after being multiplied by the factor associated with the feature game reel that provided the free games.
